(19) United States
(12) Patent Application Publication
(10) Pub. No.: US 2008/0279116 A1
(43) Pub. Date: Nov. 13, 2008

(54) Method For Obtaining Configuration Data For a Terminal By Using the Dhcp Protocol

(75) Inventors: Stephane Tuffin, Rospez (FR); Francois Bourdais, Antibes (FR)

Correspondence Address: OBLON, SPIVAK, MCCLELLAND MAIER & NEUSTADT, P.C., 1940 DUKE STREET, ALEXANDRIA, VA, 22314, US

(73) Assignee: FRANCE TELECOM, PARIS (FR)

(21) Appl. No.: 11/994,036

(22) PCT Filed: Jun. 22, 2006
(86) PCT No.: PCT/FR06/50621

§ 371 Date: May 28, 2008

(30) Foreign Application Priority Data
Jun. 28, 2005 (FR) 0506572

(51) Int. Cl. H04L 12/28

(52) U.S. Cl. 370/254

(57) ABSTRACT

A method of obtaining configuration data for a terminal using the DHCP protocol. The method includes inserting optional data including an identifier into a predefined option field of a DHCP request sent by a DHCP client module to obtain configuration data, directly or indirectly, with a single user of the terminal, to obtain configuration data customized for the user.

The invention relates to a method of obtaining configuration data for a terminal using the DHCP protocol. More specifically, the subject of the invention is a method of obtaining configuration data for a terminal and a method of processing, by a server, one or several DHCP requests sent by a DHCP client module of a terminal to obtain configuration data for said terminal.

The DHCP protocol (Dynamic Host Configuration Protocol) enables a terminal connected to a network to obtain configuration data, notably an IP (Internet Protocol) address, from a processing server connected to this same network. This protocol defines a set of requests for setting up a dialog between, on the one hand, a client module implemented in the terminal and, on the other hand, a server module implemented in the server. These requests are sent either directly from the client module to the server module and vice versa, or via a DHCP relay.

The DHCP protocol can be used for different types of terminals: PCs, routers, IP telephones, set top boxes, videophones, video cameras, and so on, provided that such a terminal comprises a DHCP client module able to dialog with a DHCP server module. Such terminals are hereinafter simply called IP terminals.

To take account of this wide range of IP terminals when processing DHCP requests, the DHCP protocol specifies that the DHCP requests sent from a given terminal must contain the terminal's MAC address. This MAC address is a means of univocally identifying the network interface of the terminal, but it is inadequate for determining the nature of the terminal.

The DHCP protocol moreover provides for the DHCP requests to be able to contain optional data making it possible to manage the diversity of the terminals or the diversity of the needs of the users of these terminals. This optional data is inserted into an option field of the request and comprises, for example:
data that identifies the terminal type, this data being sent using option 60 of the DHCP protocol (Vendor Class Identifier);
data that identifies a user group or a set of applications associated with this user group, this data being sent using option 77 of the DHCP protocol (User Class);
data that identifies the incoming network line of the request, when the requests are intercepted by a DHCP relay interconnecting at least two networks, this data being sent using option 82 of the DHCP protocol.

This various data makes it possible to process the DHCP request that contains it in an appropriate way. In practice, it is in particular possible to generate a response that depends either on the sending terminal type, or on the user group, or even on the request's terminating network. In particular, the generated IP address can depend on this data. The dynamic assignment of IP addresses to the terminals of a network can thus be executed automatically, from such data.

However, there are particular cases in which certain users, belonging to a given user group, may have specific needs in terms of network configuration. Certain users may thus need a static IP address—and not a dynamic IP address—that allows them access to a particular service, for example a database that identifies the user from his IP address and accordingly determines the rights of access to the data in the database.

One known solution to this type of problem is to manually assign a static IP address to the terminal. The drawback is that this solution presupposes an intervention on the part of the IT maintenance personnel for each case. Furthermore, it works only where the need is for a static IP address.

One aim of the invention is to provide a method of obtaining configuration data for a terminal by means of DHCP requests and a method of processing such requests, which do not present the drawbacks mentioned above for the prior art solutions, which are compatible with the DHCP protocol and in particular provide for a management of the configuration data of the various terminals of a network which can be fully automated and is adaptable to the specific needs of certain users.

To this end, the subject of the invention is a method of obtaining configuration data for a terminal, the terminal comprising a DHCP client module able to communicate via a network with at least one DHCP server module in accordance with the DHCP protocol, the method comprising the following steps:
generation by said DHCP client module of one or several DHCP requests to obtain configuration data for said terminal,
transmission of said one or several DHCP requests via said network by said DHCP client module to said at least one DHCP server module,
reception of the configuration data received by said DHCP client module in response to at least one of said one or several DHCP requests,

wherein the method furthermore comprises a step consisting in inserting, into a predefined option field of at least one of the DHCP requests, optional data comprising an identifier associated, directly or indirectly, with a single user of said terminal, and said received configuration data is customized for said user.

The insertion in one of the requests for an identifier, associated with one, and only one, user of the terminal, makes it possible to generate a response to this request which is customized for a given user, identified indirectly or indirectly by the inserted identifier. This way, the configuration data can be generated so as to meet the specific needs of a given user.

Furthermore, the method makes it possible to envisage a check on the generation of configuration data, and in particular, to identify the user immediately he connects to the network, or even to refuse to assign configuration data so as to prevent a user from accessing the network. The network access security procedure therefore takes place immediately the configuration request is made, and is therefore tightened.

The method also provides a practical response to roaming situations in which one and the same user can be connected to a network, each time using a different terminal, for example using one of a plurality of self-service terminals.

Finally, the method is also compatible with the DHCP protocol and does not require the basic principles of this protocol to be modified.

According to one advantageous embodiment, the method comprises a step consisting in reading all or part of the optional data from a personal storage medium accessible from the terminal. Such a storage medium is typically a chip card. This embodiment provides a means of facilitating the step for inserting the identifier into the DHCP request, a simple chip card reading device being needed.

According to a variant of this embodiment, the personal storage medium is a medium with access to it secured by an identification code. This provides a means of securing access to this identifier and entering it into the request, and reduces the chances of a fraudulent use of the personal storage medium succeeding.

According to another variant of this embodiment, the personal storage medium is of the removable medium type. A user on the move can thus be provided with his removable medium to obtain an appropriate and customized configuration regardless of the terminal that he uses.

According to another variant of this embodiment, the personal storage medium is incorporated in a mobile terminal and can be accessed from said terminal by a local communication link set up between said terminal and said mobile terminal. This variant avoids the user of a mobile terminal, for example a cell phone, having to be provided with an additional medium to store the identifier.

The identifier can be, for example:
an identifier of said user,
a registration identifier of a personal storage medium associated with said user,
an identifier of an object associated with said user,
an identifier of a service associated with said user,
a user profile identifier associated with said user.

Any type of identifier can thus be used to implement the inventive method, and there is no need to have an identifier for the user himself. For example, the use of a registration identifier for a personal storage medium as the identifier facilitates the implementation of the method, since such an identifier preexists and databases and known methods are available for processing such identifiers, and making it possible, if necessary, to determine the identity of the user from such identifiers.

According to an advantageous embodiment, all or part of the optional data is inserted into the request in encrypted form. This provides a way of reinforcing the confidentiality of the exchanges and limits the chances of fraudulent connection attempts succeeding.

Another subject of the invention is a terminal comprising a DHCP client module, suitable for implementing the inventive method, and comprising
a module for provoking the insertion of said optional data into said predefined option field,
a module for provoking the reading of all or part of said optional data from a personal storage medium associated with said user and accessible from the terminal.

In a complementary way, another subject of the invention is a method of processing, by a server, one or several DHCP requests sent by a DHCP client module of a terminal to obtain configuration data for said terminal, the server comprising a DHCP server module able to communicate with the DHCP client module via a network in accordance with the DHCP protocol, at least one of said one or several received DHCP requests comprising, in a predefined option field, optional data comprising an identifier associated, directly or indirectly, with a single user of said terminal, the method comprising steps consisting in
generating the requested configuration data, the configuration data being customized for said user,
transmitting to said DHCP client module the configuration data in response to at least one of said one or several DHCP requests.

According to an advantageous embodiment, the generated configuration data comprises an IP address, the static or dynamic type of which depends on said identifier. The method thus provides a way of implementing an automatic procedure for managing static addresses based on the knowledge of each of the identifiers associated with the users needing a static address.

According to an advantageous embodiment, the method comprises a step consisting in storing, for each request comprising said predefined option field, tracking data including information on the date and/or time of reception of said request. In this embodiment, it is possible to track a given user by the identifier or identifiers associated with him and consider putting in place billing or connection tracking functions.

According to an advantageous embodiment, the method comprises steps consisting in determining the identity of said user from said identifier, generating the requested configuration data according to the identity of said user if the user is identified, refusing to generate the requested configuration data if said user is not identified. This embodiment provides a way of tightening network access security from the configuration request processing step.

Another subject of the invention is a server comprising a DHCP server module, suitable for implementing the inventive method, and comprising a module for generating said requested configuration data according to said identifier.

According to an advantageous embodiment, the server includes a database containing a list of identifiers and, for each identifier, data corresponding to a description of the configuration needs of the user associated with this identifier.

### DESCRIPTION OF THE DRAWINGS

Other aims, features and advantages of the invention will become apparent from the following description, given only as a non-limiting example, and with reference to the appended drawings in which

FIG. 1 is a simplified representation of the architecture of a system for implementing the invention,

FIG. 2 diagrammatically illustrates various phases of the inventive method and the data interchanges between the entities involved in these various phases.

The invention is described in the context of its application to a situation in which a customer of a service provider wants to access services made available through terminals accessing a network. The terminals are, in this example, self-service terminals.

The customer begins by registering with the service provider for some predefined services. In exchange, the service provider provides him with a chip card. This chip card contains information on the customer himself (identifier Y), service type information (the customer has subscribed to service X, the customer has taken out a 12-month subscription) or a combination of information (customer Y has taken out a 12-month subscription to the service X).

The customer purchases or obtains from the service provider a terminal to access the subscribed services. This terminal has a standard configuration which is, for example, a configuration allowing this terminal to be used only locally, with no network connection. To allow access to the services to which a given user has subscribed, it must be configured appropriately, and in particular have a DHCP address enabling it to access the services implemented via the network. With the invention, this terminal can be configured each time according to the identity of the user who connects to the network via this terminal, and this from the moment when the connection to the network from the terminal is set up.

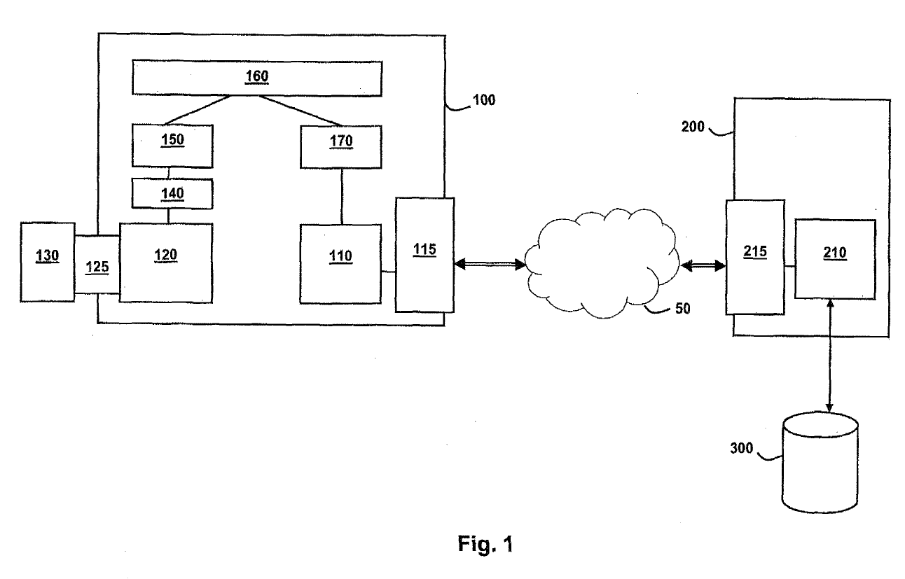

FIG. 1 is a simplified representation of the main elements cooperating in a system of such a terminal. In the system shown, the terminal 100 is in communication via a communication network 50 with a data processing server 200 accessing a database 300.

The terminal 100 is in this example a microcomputer. Generally, this terminal can be any type of terminal including a DHCP client module allowing access to the network 50.

The terminal 100 includes a network card 115 compatible with the communication network 50. It also includes a chip card reader 125. As a variant, the chip card reader 125 can be connected to this terminal 100 via an external communication port or even by a communication link with the terminal 100 instead of being incorporated in the terminal 100.

The terminal 100 includes various software modules:
a DHCP client module 110,
a driver 140 suitable for the chip card reader,
a read module 150 accessing the chip card data via the driver 140,
a data insertion module 170 used in conjunction with the DHCP client module 110,
a middleware-type communication interface 160 enabling the communication between the read module 150 and the insertion module 170.

The DHCP client module 110 of the terminal is suitable for interfacing with the data insertion module 170. Either the DHCP client module 110 includes a software interface for communicating or interfacing with the insertion module 170, or it fully incorporates the data insertion module 170.

The chip card acts as a personal storage medium. Any other form of personal storage medium capable of storing data can also be considered: a USB electronic key connected via a USB port, a SIM card of a cell phone accessible via a Bluetooth link between the terminal and the phone, and so on. The means of accessing the storage medium (in the example described, the driver 140) are each time suited to the storage medium used.

Preferably, access to the storage medium is secured so as to prevent fraudulent access to the data that it contains or identity spoofing. This access securing procedure usually consists in allowing access to the chip card data only after entering a confidential code.

Preferably, the storage medium is a removable medium of the chip card type so that a given user can easily, even when a frequent traveler, connect from any terminal and retrieve a configuration that is appropriate to his needs.

To return to FIG. 1, the data processing server 200 includes a network interface card 215 compatible with the communication network 50. It also includes a software module called DHCP server module 210.

The DHCP client module and the DHCP server module are designed to dialog between themselves according to the DHCP protocol as defined by the IETF (Internet Engineering Task Force) in the RFC 2131 standard. This protocol in particular defines how a client terminal including a DHCP client module obtains its network configuration (its IP address, normally) from a DHCP server including a DHCP server module.

The requests sent by the client module to the server module are, for example:
a “DHCP DISCOVER” request, by which the client module tests for the presence of one or more DHCP servers on the network and asks for a dialog to be set up with one of these servers;
a “DHCP REQUEST” request, by which the client module requests configuration data from the server that has responded to its previous “DHCP DISCOVER” request;
a “DHCP REQUEST RENEWAL” request, by which the client module renews its preceding “DHCP REQUEST” request.

The DHCP requests sent by a DHCP client module can contain optional data. This data is identified in a DHCP request by an option code. For example, an option code 60 indicates the presence of data identifying the terminal type.

According to the invention, an option field is used that is provided in the DHCP protocol for inserting, into the DHCP request sent by the DHCP client module, an option code and data associated with this option code.

The inserted DHCP option conforms to the RFC 2489 standard. It is defined by:
an option code, for example code 180,
a parameter indicating the format of the data associated with the option, for example “string”,
a parameter indicating the quantity of data associated with the option, for example in the form of a number of characters.

Hereinafter in the description, such an option will be called “option 180” or “user option”. This predefined option code identifies the option field into which the identifier is inserted and indicates that the configuration data requested by the client module is to be generated according to said identifier, and more specifically, that it is to be customized for the user associated with this identifier.

According to the invention, the data associated with the option code 180 comprises an identifier associated, directly or indirectly, with one, and only one, user of the terminal 110. Such an identifier is a way of unambiguously determining the identity of the user associated with this identifier.

Such an identifier can be, by choice:
an identifier of the user himself, for example his name, first name;
an identifier of the user himself in coded form, which is assigned to this user and provides a way of identifying him from other users within a given organization; it may be, for example, an employee identifier assigned to the user in the company for which he works or even a customer identifier assigned to the user via a service-provider organization of which this user is a customer;
a chip card registration identifier, from which the identity of the user can be determined, the user associated with this identifier being in this case the owner of the chip card;
a telephone number type identifier, from which the identity of the user can be determined, the user associated with this identifier being in this case the subscriber to the telephone line identified by this number,
an identifier of an object or of a service associated with a single user,
an identifier of an abstract entity associated with a single user, for example a user profile identifier associated with this user, and so on.

A predefined option code identifying said option field is preferably used to indicate the presence of such an identifier and specify to the module processing the request that the requested configuration data is to be customized for the user associated with this identifier.

Other data can also be inserted into the request. This may or may not be taken from the chip card. It may in particular be useful to insert data identifying or describing a user profile. It is possible, in practice, to envisage a user needing to connect to the terminal with different types of profiles. A user profile comprises, for example, information identifying the services that can be accessed from the terminal to which this user has subscribed. A user profile can also comprise information on the conditions governing access to these services: time band, number of accesses, and so on.

As a variant, only a profile identifier is inserted into the request, the server 200 in this case being able to restore the information relating to the services associated with this profile from the database 300.

Furthermore, as indicated above, the profile identifier can be the one and only data item incorporated in the option field 180, because it can be used to identify the user of the terminal if this profile identifier is associated with just one user.

To this end, since the database preferably contains a list of identifiers, and for each identifier, data corresponding either to information relating to the services subscribed to by the user associated with this identifier, or to a description of the configuration needs of the user associated with this identifier (address type, access rights, etc.), or to the configuration data itself (in the case of a static address, the address needs to be stored). In this way, the server is thus able, without even knowing the identity of the user, to generate customized configuration data.

The data inserted into the request and associated with the option code 180 is preferably taken from the chip card. In addition, data from a different source, for example non-confidential data, can also be inserted into the request.

All or part of the data associated with the option 180 can be encrypted. The encryption of this data can be performed either before the data is inserted into the request, or before the data is stored on the chip card. In this second variant, the risks of identity spoofing are greatly reduced, especially if access to the information medium is also secured.

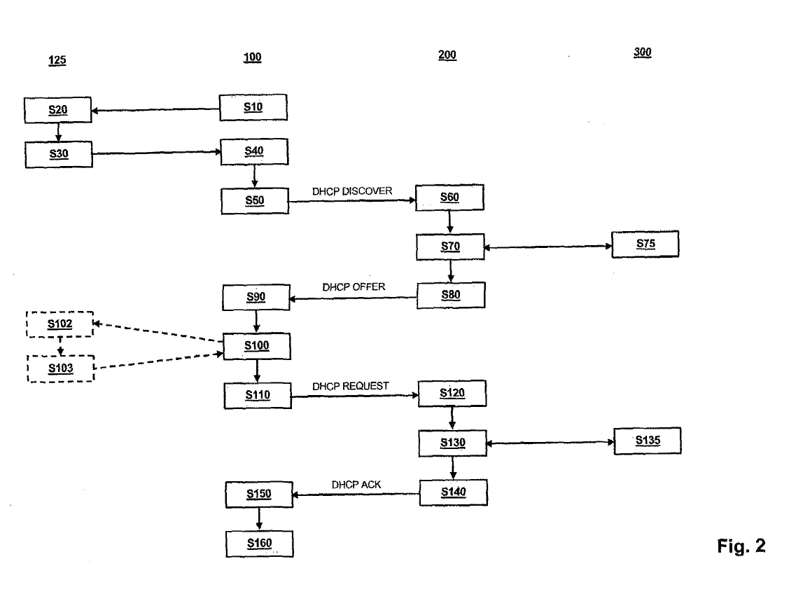

FIG. 2 illustrates the various phases of the inventive method and the data interchanges performed in these various phases between the terminal 100, the server 200, the reader 120 and the database 300.

After starting up the terminal 100 and inserting the chip card 130 into the reader 120, the steps S10 to S160 proceed as follows:
S10: the terminal 100 generates a “DHCP DISCOVER” request and prompts for the insertion of an option 180 comprising data present in the chip card 130; this data comprises in particular an identifier associated with a user of the terminal 100;
S20: the reader 120 receives a data read instruction;
S30: the reader 120 reads the requested data from the chip card 130 and returns it to the terminal;
S40: the terminal 100 receives the data read from the chip card 130;
S50: the terminal 100 inserts the received data into the “DHCP DISCOVER” request, then sends this request to the server 200;
S60: the server 200 receives the “DHCP DISCOVER” request;
S70: the server 200 processes the “DHCP DISCOVER” request by, if necessary, accessing S75 the database 300; this processing operation is performed by taking into account all or part of the data read from the chip card and inserted into the request; the server 200 generates a response which, preferably, depends on the identifier inserted into the request;
S80: the server 200 sends a response to the “DHCP DISCOVER” request in the form of a “DHCP OFFER” request;
S90: the terminal 100 receives the “DHCP OFFER” response;
S100: the terminal 100 generates a “DHCP REQUEST” request and inserts therein all or part of the data previously read from the card;
S110: the terminal 100 sends this “DHCP REQUEST” request to the server 200;
S120: the server 200 receives the “DHCP REQUEST” request;
S130: the server 200 processes the “DHCP REQUEST” request by, if necessary, accessing S135 the database 300;
S140: the server 200 sends a response to the “DHCP REQUEST” request in the form of a “DCHP ACK” request including an IP address intended for the configuration of the terminal 100;
S150: the terminal 100 receives the “DHCP ACK” response;
S160: the terminal 100 proceeds with its IP configuration based on the IP address returned by the server 200.

A DHCP request is constructed by the terminal 100 by the following steps:
the DHCP client module 110 creates a DHCP request;
the DHCP client module 110 transfers this request to the insertion module 170;
the insertion module 170 sends a request to the read module 150 via the middleware 160 to extract the data from the chip card;
the read module 150 obtains the requested data from the driver 140 of the card reader 120;
the read module 150 returns the requested data to the insertion module 170 via the middleware 160;
the insertion module 170 inserts the data into the created DHCP request and transfers it to the DHCP client module 110;
the DHCP client module 110 sends the DHCP request to the DHCP server module 210 and awaits its response.

Each DHCP request generated can include an option 180 and associated data. In the example described, it is the “DHCP DISCOVER” and “DHCP REQUEST” requests which contain information on the identity of the user of the terminal. All the requests sent by the DHCP client module (“DHCP REQUEST RENEWAL”, “DHCP INFORM” and “DHCP RELEASE”) can, depending on the requirement, contain this information.

Depending on the variants of embodiment, the chip card will or will not be accessed each time a client DHCP request is generated to read therefrom the data to be inserted. Thus, the step S100 for generation of a “DHCP REQUEST” request may entail substeps S102 and S103 for accessing the chip card and reading data from the chip card.

The DHCP server is configured to use information set in the chosen DHCP option in different ways:
to perform access-control type operations according to the identity of the user and respond only to the terminals that send information associated with a known user; in this case, the security of the DHCP service is enhanced since only the authorized terminals are configured; in this situation, authentication data (password, certificate, etc.) can be inserted into the DHCP request with the data making it possible to identify the user and enable the server to authenticate the current user of the terminal sending the request;
to store tracking data (in particular the date and/or time of reception of the request) concerning the connections requested by a given user, that is, for the requests that include the option field 180; in this case, the service provider can implement user-oriented billing, for example according to the number of connections or connection duration, the tracking data being cross-referenced with the information linking a customer to a chip card;
to send a response which is customized according to the identity of the user or according to the services to which this user has subscribed; for example by generating configuration data according to the identifier and/or the identity of the user.

These various operations are preferably performed when processing the client DHCP request and before the response to this request is generated. When the operation concerned is simply to store tracking data, it can optionally be executed after the response to the client request has been sent.

To generalize, the processing by the server 200 of the DHCP request sent by the terminal 100 is performed according to the data in the optional data field. This data comprises an identifier unequivocally associated with the user of the terminal 100. It is, in particular, an identifier enabling the user of the terminal 100 to be identified unequivocally.

Based on the data associated with the DHCP option, the DHCP server determines, before processing the DHCP request, the identity of the user of the terminal 100 and processes the request according to the identity of the user. Thus, operations like the storage of tracking data, the processing of the data associated with the request, access control based on the data associated with the request or the generation of the response to the request, can be performed according to the identity of the current user of the terminal 100.

As a variant, the step for determining the identity of the user of the terminal can be avoided, if the server is designed to respond to the request solely on the basis of the identifier, in particular if the server includes a database storing the configuration needs of the user in conjunction with the identifier.

For example, if the database 300 contains a table of the services subscribed to by the various users, a table that is indexed by a user identifier, the DHCP server uses the identifier associated with the user to identify the services subscribed to by this user and returns a response (configuration data) which is suited to the services subscribed to.

In particular, the DHCP configuration returned by the server in response to a “DHCP REQUEST” request can be dependent on the identifier, and therefore the identity of this user. It is thus possible for the static or dynamic type of the returned address to also be dependent on the identity of this user. In the exemplary case where the user needs a static address, the server will constantly return a predefined static address suited to the needs of this user.

1. A method of obtaining configuration data for a terminal, the terminal comprising a DHCP client module able to communicate via a network with at least one DHCP server module in accordance with the DHCP protocol, the method comprising:
generating by said DHCP client module one or plural DHCP requests to obtain configuration data for said terminal,
transmitting said one or plural DHCP requests via said network by said DHCP client module to said at least one DHCP server module,
receiving the configuration data received by said DHCP client module in response to at least one of said one or plural DHCP requests, and
inserting, into a predefined option field of at least one of said one or plural DHCP requests, optional data comprising an identifier associated, directly or indirectly, with a single user of said terminal, and said received configuration data is customized for said user.

2. The method as claimed in claim 1, wherein the method further comprises reading all or part of the optional data from a personal storage medium accessible from the terminal.

3. The method as claimed in claim 2, wherein said personal storage medium is a medium with access to it secured by an identification code.

4. The method as claimed in claim 2 or 3, wherein said personal storage medium is of the removable medium type.

5. The method as claimed in claim 2, wherein said personal storage medium is incorporated in a mobile terminal and can be accessed from said terminal by a local communication link set up between said terminal and said mobile terminal.

6. The method as claimed in claim 1, wherein said identifier is part of the group comprising:
an identifier of said user,
a registration identifier of a personal storage medium associated with said user,
an identifier of an object associated with said user,
an identifier of a service associated with said user,
a user profile identifier associated with said user.

7. The method as claimed in any one of claims claim 1, wherein said optional data also includes data comprising an identification of at least one service to which the user has subscribed.

8. The method as claimed in claim 1, wherein all or part of the optional data is inserted into the request in encrypted form.

9. A method of processing, by a server, one or plural DHCP requests sent by a DHCP client module of a terminal to obtain configuration data for said terminal,
said server comprising a DHCP server module able to communicate with said DHCP client module via a network in accordance with the DHCP protocol, said method comprising
generating the requested configuration data, and
transmitting to said DHCP client module the configuration data in response to at least one of said one or several DHCP requests,
wherein at least one of said one or plural received DHCP requests comprises, in a predefined option field, optional data comprising an identifier associated, directly or indirectly, with a single user of said terminal and the generated configuration data is customized for said user.

10. The method as claimed in claim 9, wherein the generated configuration data comprises an IP address, the static or dynamic type of which depends on said identifier.

11. The method as claimed in claim 9 or 10, wherein the method further comprises
determining the identity of said user from said identifier,
generating the requested configuration data according to the identity of said user if the user is identified, and
refusing to generate the requested configuration data if said user is not identified.

12. The method as claimed in claim 9, wherein the method further comprises storing, for each request comprising said predefined option field, tracking data including information on the date and/or time of reception of said request.

13. A terminal comprising a DHCP client module, suitable for implementing the method as claimed in claim 1, and comprising
a module for provoking the insertion of said optional data into said predefined option field, and
a module for provoking the reading of all or part of said optional data from a personal storage medium associated with said user and accessible from the terminal.

14. A server comprising a DHCP server module, suitable for implementing the method as claimed in claim 9, and comprising a module for generating said requested configuration data according to said identifier.

15. The server as claimed in claim 14, including a database containing a list of identifiers and, for each identifier, data corresponding to a description of the configuration needs of the user associated with this identifier.

16. A data a signal to be sent by a DHCP client module able to communicate via a network with at least one DHCP server module in accordance with the DHCP protocol, said data signal comprising a DHCP request to obtain configuration data for a terminal with optional data comprising an identifier associated, directly or indirectly, with a single user of said terminal, to obtain configuration data that is customized for said user.
